(19) United States
(12) Patent Application Publication
(10) Pub. No.: US 2008/0087658 A1
(43) Pub. Date: Apr. 17, 2008

(54) Heating assembly

(75) Inventor: Charlie Huang, Taipei (TW)

Correspondence Address: BACON & THOMAS, PLLC, 625 SLATERS LANE, FOURTH FLOOR, ALEXANDRIA, VA, 22314, US

(73) Assignee: Petatech International Co., Ltd., Taipei (TW)

(21) Appl. No.: 11/580,982

(22) Filed: Oct. 16, 2006

(51) Int. Cl. H05B 3/02

(52) U.S. Cl. 219/441

(57) ABSTRACT

A heating assembly comprising of a defined space fitting a temperature sensor. The placement of the temperature sensor in the space would reduce environmental influences on it.

### BACKGROUND OF THE INVENTION

1. Field of the Invention

The invention relates to a heating assembly, more particularly to a heating assembly that has a temperature sensor that has reduced thermal influence from the environment.

2. Description of the Related Art

Humans are endotherms, organisms capable of maintaining a certain body temperature despite environmental stress. Yet the homeostasis ability of the human body is limited; if a person is exposed to an overly cold environment, he/she may experience frostbite and hypothermia. Thus people wear warm clothing to protect themselves from the cold. Yet warm clothing merely traps heat from the wearer rather than producing heat itself, and is therefore unable to protect a person from extreme cold conditions. Hence a market for heat generating appliances has been thriving to fulfill this need.

In U.S. Pat. No. 6,802,081, the applicant proposed a heating suit that produced heat by using a chemical reaction. This chemical reaction takes place in a phase change fiber that produces heat by absorbing moisture. Supposedly, this suit provides suitable warmth and flexibility for the user. Yet there are many flaws to this invention. The moisture used in the chemical reaction is provided from the sweat of the wearer, which means that the heating process is slow and unstable. Furthermore it is illogical to use human sweat to regulate the heating system due to the inherent positive feedback loop; a hot person would sweat and be heated from the suit, while a cold person would not sweat and not receive any heating from the suit. Hence this heating suit is highly impractical.

In other inventions, people have used a Joule heating assembly (passing electricity through a heating wire to generate heat) to heat a suit. However if this heating assembly is allowed to run on its own, the electrical resistors would heat to a point that the user would be burned. Thus producers of this type of heating assembly often place a temperature sensor within it that would measure the temperature of the heating assembly and send signals to reduce heating once the heating assembly reaches a certain temperature. But in many of these heating assemblies, the temperature sensor is simply placed in contact with the heating wire, thus exposing the temperature sensor to environmental influences and having the temperature sensor miscalculate the heat of the heating system. For example, if a person wears this suit under extreme cold conditions, the temperature sensor would be influenced by the cold surroundings and send out readings lower than the actual temperature of the heating wire, and thus the heating wire might overheat and burn the user.

Therefore, it is desired to provide an electrical heating assembly with a temperature sensor that has increased accuracy due to reduced environmental thermal influence.

### SUMMARY OF THE INVENTION

A primary objective of the present invention is to reduce the environmental thermal influence on the temperature sensor of a heating assembly and thus improve the accuracy of the temperature sensor.

A secondary objective of the present invention is to increase the safety range of the temperature released by the heating assembly by using the increased accuracy of the temperature sensor.

A third objective of the present invention is to increase the highest safety temperature released by the heating assembly by using the increased safety range of the temperature released by the heating assembly.

A fourth objective of the present invention is to improve the safety of a heating assembly by being able to accurately measure when the heating assembly is overheating by using the increased accuracy of the temperature sensor.

The present invention is a heating assembly adapted to be driven by a power system including a power device and a control device for controlling the power device, the heating assembly comprising: a heating device having a heating wire and defining a space; and a temperature sensor sized to fit within the space and outputting temperature readings to the control device. The space is defined to be an area under substantial thermal influence from the heating wire. The placement of the temperature sensor in the space would reduce the environmental thermal influences on the temperature sensor and thus increase the accuracy of the temperature sensor. The increased accuracy of the temperature sensor would allow two things: one, an increased safety range of temperature given off by the heating assembly that would allow an increased maximum safety temperature released by the heating assembly; two, an improved safety of the heating assembly by being able to accurately measure when the heating assembly is overheating.

### BRIEF DESCRIPTION OF THE DRAWINGS

The present invention will be apparent to those skilled in the art by reading the following detailed description f a preferred embodiment thereof, with reference to the attached drawings, in which:

FIG. 1 is a relationship diagram of the components of the present invention.

FIG. 2 is a schematic side view of the first preferred embodiment

FIG. 3 is a schematic side view of the second preferred embodiment

FIG. 4 is a schematic side view of the third preferred embodiment

### DETAILED DESCRIPTION OF THE PREFERRED EMBODIMENT

Other features and advantages of the present invention will become apparent in the following detailed description of the preferred embodiments with reference to the accompanying drawings.

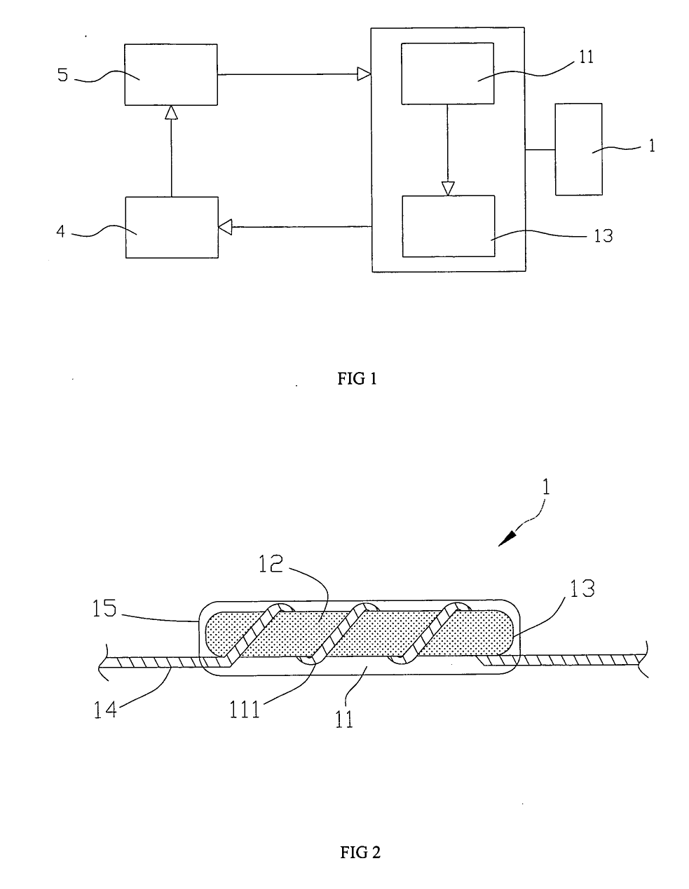

Referring to FIG. 1 and FIG. 2, the first preferred embodiment of the heating assembly 1 defines a space 12 within a spiraled bent wire section 111 of the heating wire 14 of the heating device 11, and the temperature sensor 13 is placed within the space 12. In this embodiment, when the electrical source 5 passes electricity through heating wire 14, the electrical resistivity of heating wire 14 would transform the electrical energy into heat energy, thus heating the heating wire 14. The temperature sensor 13 held within the heating device 11 would then measure the temperature of heating wire 14 accurately due to its placement in space 12 and send the temperature readings to control device 4. Control device 4 would then take these readings and adjust the temperature of heating wire 14 accordingly by altering the electrical output of the electrical source 5 according to some predetermined control mechanisms. An insulating material 15 encloses both the heating device 11 and the temperature sensor 13, thus decreasing the error of the temperature readings of temperature sensor 13 caused by the environmental temperature.

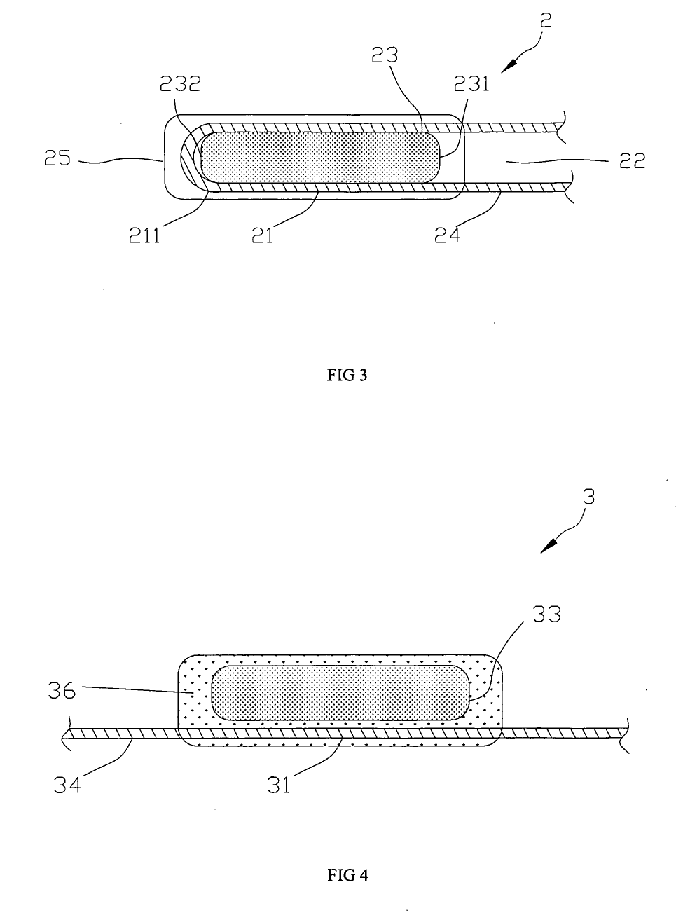

FIG. 3 illustrates the second preferred embodiment of this invention, where the heating device 21 of heating assembly 2 has a section of the heating wire 24 that forms a “U” shape by being placed from one end 231 of the temperature sensor 23, along the surface of temperature sensor 23, to the other end 232 of the temperature sensor 23, and then back along another side of temperature sensor 23. Thus the curved section 211 of heating wire 24 forms a space 22 wherein temperature sensor 23 is placed. The temperature sensor 23 is sized to fit within space 22. Furthermore an insulating material 25 could enclose both the heating device 21 and temperature sensor 23, thus reducing the effects the environmental temperature has on temperature sensor 23. Once heating wire 24 starts to give off heat, temperature sensor 23 would accurately measure the temperature released by heating device 21 and send these temperature readings to control device 4. Control device 4 would then take these readings and adjust the temperature of heating wire 24 accordingly by altering the electrical output of the electrical source 5 according to some predetermined control mechanisms. The increased accuracy of the temperature sensor 23 decreases the need to restrict the range of heat released by the heating wire 24 to account for errors in the temperature readings from temperature sensor 23, thus maximizing the range of temperature which the heating device 21 could run and offering the user with safety from overheating the heating device 21 and comfort.

FIG. 4 illustrates the third preferred embodiment of this invention heating assembly 3, where a heat conducting material 36 thermally connects a section of heating wire 34 with temperature sensor 33 in order to allow temperature sensor 33 to accurately measure the temperature of heating wire 34 and to reduce the effects of the environmental temperature on temperature sensor 33.

Those skilled in the art would recognize the fact that the control device does not necessarily have to control the electrical output of the power source in order to alter the temperature of the heating wire. In essence, the control device is responsible for controlling the temperature of the heating wire; the means which the control device controls the temperature of the heating wire is not limited.

In summary of the descriptions above, this invention is a heating assembly that encloses a temperature sensor in close contact with a heating device, thus reducing environmental thermal influence on the temperature sensor and thus increasing the accuracy of the temperature sensor, hence accomplishing the goals of this invention.

While the present invention has been described in connection with what is considered the most preferred and practical embodiments, it is understood that this invention is not limited to the disclosed embodiments but is intended to cover various arrangements included within the spirit and scope of the broadest interpretation so as to encompass all such modifications and equivalent arrangements.

I claim:

1. A heating assembly adapted to be driven by a power system including a power device and a control device for controlling the power device, the heating assembly comprising:
a heating device having a heating wire and defining a space; and
a temperature sensor sized to fit within the space and outputting temperature readings to the control device.

2. The heating assembly as claimed in claim 1, wherein the heating wire includes a bent section forming the space.

3. The heating assembly as claimed in claim 2, wherein the bent section is a spiral.

4. The heating assembly as claimed in claim 2, wherein the bent section is an “U” shaped section.

5. The heating assembly as claimed in claim 2, wherein the heating device further includes a thermally conductive portion that encloses and thermally connects the bent section with the temperature sensor.

6. The heating assembly as claimed in claim 5, wherein the thermally conductive portion is a thermally conductive gel.

7. The heating assembly as claimed in claim 1, further comprising a thermally insulating material enclosing the heating device and the temperature sensor.
